(19) United States
(12) Patent Application Publication
(10) Pub. No.: US 2024/0319424 A1
(43) Pub. Date: Sep. 26, 2024

(54) PATTERNED COATABLE THIN-FILM POLARIZER BASED ON LYOTROPIC LIQUID CRYSTAL

(71) Applicant: LIGHT POLYMERS HOLDING, Grand Cayman (KY)

(72) Inventors: James Chen, Taoyuan (TW); Evgeny Morozov, Burlingame, CA (US); CC Hsiao, Taipei City (TW); Valeriy Kuzmin, Castro Valley, CA (US)

(21) Appl. No.: 18/612,533

(22) Filed: Mar. 21, 2024

Related U.S. Application Data
(60) Provisional application No. 63/453,812, filed on Mar. 22, 2023.

(51) Int. Cl. G02B 5/30; C09K 19/38; C09K 19/58; G02B 1/08

(52) U.S. Cl. CPC G02B 5/3016; C09K 19/3819; C09K 19/582; G02B 1/08; C09K 2219/03

(57) ABSTRACT

A patterned linear polarizer layer is obtained by shear coating a polymeric lyotropic liquid crystal solution on a coatable substrate, drying and treating the resulting polymer layer with a doping-passivation solution containing the dopant and multi-valent cations, where the patterned structure is obtained using various methods like restricting the doping process to certain areas of the polymer layer or discoloring the doping agent in certain areas of the linear polarizer or by selective removal of parts of the linear polarizer layer and others. The thickness of the dry linear polarizer coating layer is 2.0 micrometer or less.

### CROSS REFERENCE TO RELATED APPLICATIONS

This application claims the benefit of 63/453,812, filed Mar. 22, 2023, the disclosure of which is incorporated by reference herein in its entirety.

### BACKGROUND

Polarizers are widely used as components of modern displays. In liquid crystal displays (LCD) they work as a part of ‘light valve’ to control the amount of light that is directed to the viewer and so they responsible for how the image is formed on the screen. In OLED and micro-LED displays polarizers are used to suppress reflection of the ambient light from the light-emitting surface.

Presently the polarizers are iodine doped poly(vinyl alcohol)-based films with a typical thickness of 50-80 micrometers. In display applications they are used as layers that are uniform in their optical properties across the display area.

However, in general the in-plane structure of a display is not uniform. For example, in color displays the pixels have subpixels with different color; in transmissive and transflective displays there are openings in between the pixels for the ambient light to go through. In such cases the uniform polarization over different areas may not be the best scenario as the light absorbing polarizer reduces the brightness of the display.

A patterned polarizer of CN105242342A can transmit the natural light ‘selectively and partially’, thereby increasing the transmittance of a display. Another patterned polarizer application is described in TW201247019A1 and in U.S. Pat. No. 8,796,704B2 where one subpixel is not covered by polarizing film that allows increasing brightness or reducing the size of the subpixel while the reflection of ambient light increase from that subpixel is the least noticeable among all subpixels of the display.

Patterning an iodine-PVA polarizer is a challenging task and if such a film was produced it would be another challenge to precisely transfer it into the display structure. Besides that, a cell phone display has a typical pixel size of 50 micrometers and a sub-pixel may be as small as about 10 micrometers. For such applications a patterned polarizing film should be as thin as possible to avoid issues related to optical distortions.

There is a thin-film solution by Sumitomo and Fujifilm (e.g. US20220397713A1) that can be used to create a patternable polarizer film, though considering the chemistry used it may be difficult to implement.

Therefore, there is a need for a new patternable linear polarizer technology that overcomes those mentioned and other limitations.

### SUMMARY

The present disclosure relates to patterned coatable linear polarizers from aromatic polymers complexed with dyes or iodine or mixture thereof.

A patterned linear polarizer includes a coating layer of 2 micrometers or less in thickness. The coating layer includes an aromatic polymer formed from a lyotropic liquid crystal. The coating layer may also include dopants, and multi-valent cations. The coating layer defines light polarizing areas and light non-polarizing areas, where the light polarizing areas form a pattern. The pattern may be uniform or non-uniform.

A patterned linear polarizer layer is obtained by shear coating a polymeric lyotropic liquid crystal solution on a coatable substrate, drying and treating the resulting polymer layer with a doping-passivation solution containing the dopant and multi-valent cations, where the patterned structure is obtained using various methods like restricting the doping process to certain areas of the polymer layer or discoloring the doping agent in certain areas of the linear polarizer or by selective removal of parts of the linear polarizer layer and others. The thickness of the dry linear polarizer coating layer is 2.0 micrometer or less, while the characteristic size of the lines or shapes of the patterning may be 1 micrometer or greater.

A patterned linear polarizer includes a polymeric coating layer. The polymeric coating layer contains an aromatic polymer, iodine anions and/or organic dyes, and multi-valent cations. The polymeric coating layer is 2.0 micrometers or less in thickness. The polymeric coating layer is substantially free of poly(vinyl alcohol). The patterning is obtained using various methods like restricting the doping process to certain areas of the polymer layer or discoloring the doping agent in certain areas of the linear polarizer or by selective removal of parts of the linear polarizer layer and others. A patterned circular polarizer can be obtained by combining a quarter-wave retarder and the patterned linear polarizer. The patterned linear polarizer can be incorporated into a display such as a liquid crystal display (LCD). The patterned circular polarizer can be incorporated into a display such as organic light-emitting diode (OLED) display or micro-LED display.

A patterned linear polarizer may be formed by shear coating a lyotropic liquid crystal layer onto a substrate to form an aromatic polymer layer having a thickness of 2 micrometers or less, and applying a dopant and multi-valent cations on the aromatic polymer layer to form light polarizing areas and light non-polarizing areas in the aromatic polymer layer to define a patterned linear polarizer.

A patterned linear polarizer may be formed by shear coating a lyotropic liquid crystal layer onto a substrate to form an aromatic polymer layer having a thickness of 2 micrometers or less, applying a dopant and multi-valent cations on the aromatic polymer layer, and selectively removing portions of the doped aromatic polymer layer to form light polarizing areas and light non-polarizing areas in the aromatic polymer layer to define a patterned linear polarizer.

A patterned linear polarizer may be formed by shear coating a lyotropic liquid crystal layer onto a substrate to form an aromatic polymer layer having a thickness of 2 micrometers or less, applying a mask onto the aromatic polymer layer, and doping areas of the aromatic polymer layer not covered by the mask. Multi-valent cations may be applied to the aromatic polymer layer before, during, or after the doping step.

A patterned linear polarizer may be formed by shear coating a lyotropic liquid crystal layer onto a substrate to form an aromatic polymer layer having a thickness of 2 micrometers or less, a printing a dopant onto selective areas of the aromatic polymer layer to form light polarizing areas and light non-polarizing areas (areas that are not printed) in the aromatic polymer layer to define a patterned linear polarizer. Multi-valent cations may be applied to the aromatic polymer layer before, during, or after the doping step.

The above summary of the present invention is not intended to describe each disclosed embodiment or every implementation of the present invention. The description that follows more particularly exemplifies illustrative embodiments. In several places throughout the application, guidance is provided through examples, which examples can be used in various combinations. In each instance of a list, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings, in which:

FIG. 1 is a cross-sectional diagram of an illustrative patterned linear polarizer.

FIG. 2 is a cross-sectional diagram of another illustrative patterned linear polarizer.

FIG. 3 is a cross-sectional schematic diagram view of an illustrative OLED-display with a patterned circular polarizer (CPOL).

FIG. 4 is a micro-photographic image of a patterned linear polarizer layer obtained by shear coating of the polymeric lyotropic liquid crystal, drying, manual masking and selective doping with iodine.

FIG. 5 is a micro-photographic image of a mask printed on top of a coated aromatic polymer layer obtained by shear coating of the polymeric lyotropic liquid crystal, drying and printing the mask using an ink-jet printer of Example 3.

FIG. 6 is a micro-photographic image of a patterned linear polarizer obtained by shear coating of the polymeric lyotropic liquid crystal, drying, printing a mask using an ink-jet printer, selective doping with iodine and rinsing of Example 3.

FIG. 7A is a micro-photographic image of a patterned linear polarizer layer obtained by shear coating of the polymeric lyotropic liquid crystal, drying, applying a photo-resist and selective doping with iodine and rinsing of Example 4.

FIG. 7B is the micro-photographic image of a patterned linear polarizer layer of FIG. 7A rotated 90 degrees to illustrate the polarizing effect of Example 4.

FIG. 8 is a test pattern that was used for laser engraving method of making a patterned linear polarizer of Example 5.

FIG. 9 is a micro-photograph of a patterned linear polarizer prepared by laser engraving as it is seen in polarized light of Example 5.

FIG. 10 is a patterned mask for forming the patterned linear polarizer prepared by laser irradiation of Example 6.

FIG. 11 is a micro-photograph of a patterned linear polarizer prepared by laser irradiation as it is seen in polarized light of Example 6.

### DETAILED DESCRIPTION OF ILLUSTRATIVE EMBODIMENTS

The present disclosure relates to patterned coatable linear polarizers from aromatic polymers complexed with dyes or iodine or mixture thereof.

In this disclosure:

“Aqueous” refers to a material being soluble or dissolved in water at an amount of at least 1 wt. % or at least 5 wt. % of the material in water at 20° C. and 1 atmosphere.

“Visible spectral range” refers to a spectral range between approximately 400 nm and 700 nm.

An optical coating being “substantially non-absorbing” at a certain wavelength means that its transmission of light at that wavelength is 90% or greater regardless of polarization state of the light, the transmission being normalized to the intensity of the light incident on the optical coating.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The terms “comprises” and variations thereof do not have a limiting meaning where these terms appear in the description and claims.

Unless otherwise specified, “a,” “an,” “the,” and “at least one” are used interchangeably and mean one or more than one.

Also herein, the recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

A patterned linear polarizer includes a coating layer of 2 micrometers or less in thickness. The coating layer includes an aromatic polymer formed from a lyotropic liquid crystal. The coating layer may also include dopants, and multi-valent cations. The coating layer defines light polarizing areas and light non-polarizing areas, where the light polarizing areas form a pattern. The pattern may be uniform or non-uniform.

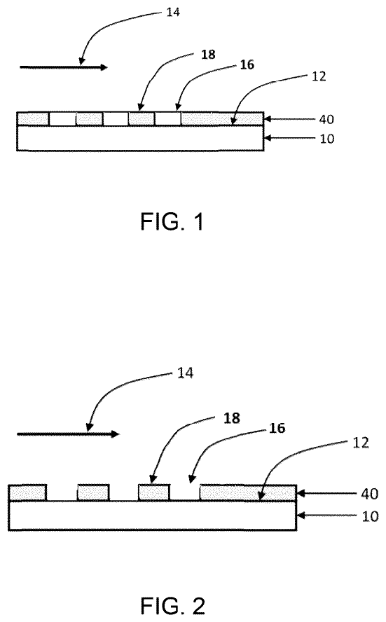

FIG. 1 is a cross-sectional diagram of an illustrative coatable substrate 10 upon which a primer 12 was coated upon which a polymeric lyotropic liquid crystal was shear coated in the direction 14 and dried to form a layer of the aromatic polymer 40, which was masked and doped to create light polarizing areas 18 and the other areas protected from doping that perform as transparent non-polarizing areas 16.

The aromatic polymer 40 forms a substantially uniform layer having a substantially uniform layer thickness along the surface of the coatable substrate 10. The aromatic polymer 40 layer is preferably 3.0 micrometers or less in thickness, or 1.0 micrometers or less in thickness. The aromatic polymer 40 layer is preferably from 0.5 to 3.5 micrometers in thickness, or from, 0.5 to 1.5 micrometers in thickness, or from 0.5 to 1.0 micrometers in thickness. The surface of the aromatic polymer 40 layer may be parallel with the surface of the coatable substrate 10 coupled to the aromatic polymer 40 layer.

This aromatic polymer 40 layer is then selectively patterned with a dopant to form light polarizing areas and areas without dopant to form non-light polarizing area along the aromatic polymer 40 layer. The dopant may comprise iodine. The dopant may comprise an anisometric dye. The anisometric dye may be a cationic dye.

The pattern on the aromatic polymer 40 layer may be formed with a mask. The mask may be a separate layer from the aromatic polymer 40 layer. The mask may be a separate layer formed on the aromatic polymer 40 layer.

The light polarizing areas may form a uniform pattern along the aromatic polymer 40 layer. The light polarizing areas may form a non-uniform pattern along the aromatic polymer 40 layer. The light polarizing areas may correspond in size and place with pixels of a display when combined with a display panel.

FIG. 2 is a cross-sectional diagram of an illustrative coatable substrate 10 upon which a primer 12 was coated upon which a polymeric lyotropic liquid crystal was shear coated in the direction 14 and dried to form a layer of the aromatic polymer 40, which was doped and further certain areas of the polarizer removed to form non-polarizing openings 16 in the pattern that has light polarizing areas 18. Alternatively, the aromatic polymer 40 can be patterned by removing certain areas and the remaining areas of the polymer doped to create the patterned polarizer areas 18.

The aromatic polymer 40 forms a substantially uniform layer having a substantially uniform layer thickness along the surface of the coatable substrate 10. The aromatic polymer 40 layer is preferably 3.0 micrometers or less in thickness, or 1.0 micrometers or less in thickness. The aromatic polymer 40 layer is preferably from 0.5 to 3.5 micrometers in thickness, or from, 0.5 to 1.5 micrometers in thickness, or from 0.5 to 1.0 micrometers in thickness. The surface of the aromatic polymer 40 layer may be parallel with the surface of the coatable substrate 10 coupled to the aromatic polymer 40 layer.

This aromatic polymer 40 layer includes a dopant to impart light polarizing properties along the aromatic polymer 40 layer. The dopant may comprise iodine. The dopant may comprise an anisometric dye. The anisometric dye may be a cationic dye. The dopant may be uniformly distributed along the aromatic polymer 40 layer.

Portions of the aromatic polymer 40 layer may be removed to from a pattern of light polarizing areas and non-light polarizing areas. The pattern on the aromatic polymer 40 layer may be formed with a mask. The mask may be a separate layer from the aromatic polymer 40 layer. The mask may be a separate layer formed on the aromatic polymer 40 layer. The pattern on the aromatic polymer 40 layer may be formed with laser ablation.

The light polarizing areas may form a uniform pattern along the aromatic polymer 40 layer. The light polarizing areas may form a non-uniform pattern along the aromatic polymer 40 layer. The light polarizing areas may correspond in size and place with pixels of a display when combined with a display panel.

The light polarizing areas 18 may have a total transmittance, averaged over 400 nm to 700 nm, of 37% or greater, and a polarization efficiency, averaged over 400 nm to 700 nm, of 96% or greater.

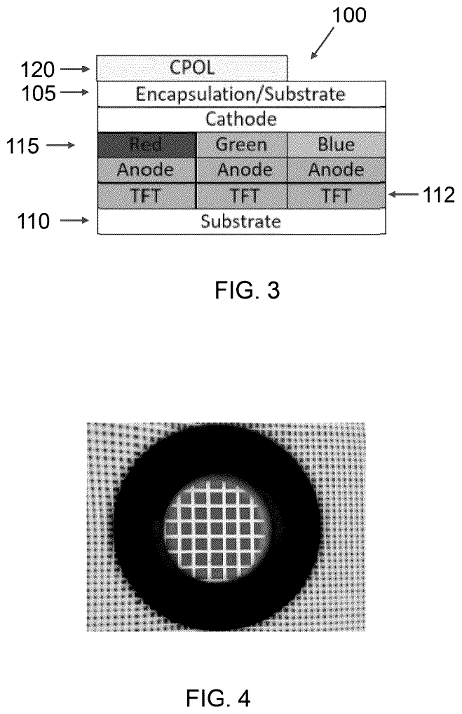

FIG. 3 is a cross-sectional schematic diagram view of an illustrative OLED-display 100 with a patterned circular polarizer 120 (CPOL), where the light emitted by Red and Green subpixels 115 is polarized and the light emitted by Blue subpixel remains non-polarized. Each pixel includes a Red, Green, and Blue subpixel. The light emitting layer 115 may be an organic light emitting diode. The light emitting layer 115 is between a cathode and anode. A thin-film transistor 112 is coupled to each subpixel and may independently drive each subpixel. The thin-film transistor 112 separates the organic light emitting diode from the substrate layer 110.

An encapsulation layer 105 may separate the organic light emitting diode from the patterned circular polarizer 120. The patterned circular polarizer 120 may be in contact with the organic light emitting diode. The patterned circular polarizer comprises the patterned linear polarizer, described herein, combined with a quarterwave retarder layer.

As discussed, the linear polarizer layer is preferably 3.0 micrometers or less in thickness, and the retarder layer is preferably 3.0 micrometers or less in thickness. The retarder layer can be configured as a quarter-wave retarder, preferably exhibiting an in-plane retardation in a range of 110 nm to 175 nm at wavelength of 550 nm, or more preferably exhibiting an in-plane retardation in a range of 130 nm to 145 nm at a wavelength of 550 nm. In order to obtain a circular polarizer, the retarder layer and the linear polarizer are oriented relative to each other to produce circular polarized light.

As illustrated in FIG. 3. The patterned circular polarizer 120 is disposed on the red and green subpixels and polarizes the red and green light from these subpixels. The patterned circular polarizer 120 layer is patterned to either not be disposed on the blue subpixel or is not capable of polarizing blue light from the blue subpixel. Each pixel may have a size from 30 to 80 micrometers and a subpixel size from 10 to 30 micrometers.

In TFT OLED displays, each pixel is divided into three sub-pixels: Red, Blue, and Green (RGB). For example, an 800×600 display has a total of 480,000 pixels, with a total of 1,440,000 RGB sub-pixels. These displays have about 2000 pixels per inch. Patterning a polarizer to polarize only one or two subpixel of each of the 480,000 pixels of the display is accomplished with the teachings of this application.

This patterned circular polarizer 120 layer has fine defined areas that are positioned on at least one subpixel and is not disposed on at least one subpixel of each pixel forming the display 100. The areas of polarizing and areas of non-polarizing on the patterned polarizer may have a largest lateral dimension from 1 micrometer to 10 millimeters, or 10 micrometers to 300 micrometers, or from 20 micrometers to 200 micrometers, or from 30 micrometers to 100 micrometers.

In TFT OLED displays, each pixel is divided into three sub-pixels: Red, Blue, and Green (RGB). For example, an 800×600 display has a total of 480,000 pixels, with a total of 1,440,000 RGB sub-pixels.

The substrate used to form the patterned linear polarizer may be a cellulose triacetate (TAC) substrate. Coating layers with high polarization efficiencies were demonstrated. Generally, the substrate can be made of various materials, for example, glass, silicon, quartz, sapphire, plastic, and/or a polymer. The substrate can be in various forms, such as a film, a sheet, or a plate. Polymeric substrates can be, for example, cellulose triacetate (TAC); polyethylene terephthalate (PET), poly(methyl methacrylate) (PMMA), polycarbonate (PC), or a cyclic-olefin polymer (COP). The substrate may be pre-treated before coating of the coating liquid to improve adhesion of the coating liquid and coating layer to the substrate. For example, the substrate may be corona treated, saponified, plasma treated, and/or primed with a primer. In some embodiments, the substrate is an optically clear adhesive (OCA) film such as an acrylic OCA film in which the coating liquid is coated on, and the coating layer is formed on, the adhesive layer of the OCA film. In some embodiments, the substrate is an optical element. “Optical element” refers to any element that has an optical function, such as focusing light, diffusing light, polarizing light, recycling light, filtering certain colors of the spectrum, and the like. Examples of optical elements include: prism film, diffuser film, brightness enhancement film, micro-lens film, color-filter array, lens, linear polarizer, circular polarizer, and reflective polarizer.

Various methods of coating the coatable liquid on the substrate are available. The coating method can be a batch process or an in-line process. In a batch process, substrates should be in the form of sheets or plates. Suitable coating methods in a batch process include slit coating, spin coating, and spray coating. In an in-line process, the substrate should be a roll of film. Suitable coating methods in an in-line (roll-to-roll) process include slot-die coating, micro-gravure coating, and comma coating.

Step-by-step instructions of forming an illustrative patterned linear polarizer are as follows. A polymeric lyotropic liquid crystal solution is prepared. The polymeric lyotropic liquid crystal solution includes an aqueous solution of an aromatic polymer. A coatable substrate is prepared. The coatable substrate includes a coatable surface. An example of a coatable substrate is a glass substrate. Another example of a coatable substrate is a TAC film substrate. The coatable surface is cleaned to reduce particles, and/or coated with a primer.

At the next step a polymeric coating layer is formed on the coatable substrate. The polymeric lyotropic liquid crystal solution is shear coated on the coatable surface of the coatable substrate. The step of shear coating a polymeric lyotropic liquid crystal solution can be done by a suitable process, such as a slit coating process. The polymeric lyotropic liquid crystal solution layer is dried to form a polymeric coating layer on the coatable substrate. The polymeric coating layer is preferably 2 micrometers or less in thickness, and more preferably 1 micrometers or less in thickness, as described herein.

At the next step, in one embodiment, a plurality of patterned insulation layers (a mask) is created over the polymeric coating layer. It can be done by a variety of methods including but not limited to ink-jet-printing, screen-printing, photolithography.

A doping-passivation solution is prepared, and then the polymeric coating layer with the patterned insulation layers is treated with the doping-passivation solution. The doping-passivation solution is a solution containing doping constituents and multi-valent cations. The doping constituents are iodine (I₂) and iodide salts or organic dye or combination of those and cause the polymeric coating layer to become doped in the unmasked areas with iodine anions (I₃⁻ and I₅⁻, for example) or dyes. The doping constituents are dissolved in aqueous solution. Upon doping, the polymeric coating layer exhibits polarization. When iodine is the dopant, the polymeric coating layer may have a thickness of 1 micrometer or less.

The multi-valent cations render the polymeric coating layer insoluble in water, by an ion exchange process. In this ion exchange process, monovalent ions of the aromatic polymers are exchanged for divalent or trivalent cations (multi-valent cations). In this case, examples of multi-valent cations are: Ba²⁺, Mg²⁺, Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Co²⁺, and Sn²⁺. Therefore, after the ion exchange, the coating layer would contain one or more of the aforementioned multi-valent cations. In preparing the doping-passivation solution, multi-valent cations are obtained by dissolving certain salts and/or compounds in solution. Some examples of these salts or compounds are: Cr₂(SO₄)₃, BaCl₂, Mg(CH₃COO)₂, SrCl₂, AlCl₃, FeSO₄, Cu(CH₃COO)₂, Zn(CH₃COO)₂, ZnI₂, ZnBr₂, ZnSO₄, ZnCl₂, Ni(CH₃COO)₂, and Co(CH₃COO)₂. For example, the doping-passivation step may include dip-coating the coated substrate in the doping-passivation solution. The areas of the polymeric coating layer, not covered by the patterned insulation layers are transformed into a linear polarizer having high polarization efficiency in the visible spectral range.

Next, it is preferable to remove excess doping-passivation solution from the linear polarizer layer and remove the patterned insulation layers. A rinse solution is prepared, and then the doped polymeric coating layer is treated with the rinse solution. For example, the rinse solution is a solution of denatured ethanol containing approximately 5% water. For example, this step may include submerging the coated substrate in the rinse solution. The patterned insulation layers may also be removed in the process of rinsing or using solvents like acetone, isopropyl alcohol, and propylene glycol monomethyl ether acetate or lift-of. Upon removal of the patterned insulation layers a plurality of polarizing stacks is formed.

In another embodiment, the entire polymeric coating layer is treated with the doping-passivation solution to form a uniform polarizing layer.

Next, it is preferable to remove excess doping-passivation solution from the linear polarizer layer. This can be done with a rinse solution and following drying. A rinse solution is prepared, and then the doped polymeric coating layer is treated with the rinse solution. For example, the rinse solution is a solution of denatured ethanol containing approximately 5% water. For example, this step may include submerging the coated substrate in the rinse solution. After rinsing the coated substrate is dried. It has been found that the step of treating the linear polarizer layer with the rinse solution helps to improve the properties of the linear polarizer layer.

At the next step a plurality of patterned insulation layers was created over the polarizing polymeric coating layer. It can be done by a variety of methods including but not limited to ink-jet-printing, screen-printing, photolithography.

Next the portions of the polarizer stack layer not covered by the plurality of patterned insulation layers are removed by etching or discoloration to form a plurality of polarizer stacks under the plurality of patterned insulation layers on the base material.

The patterned insulation layers then were removed using specific to the nature of the patterned insulation layers solvents, like acetone, isopropyl alcohol, and propylene glycol monomethyl ether acetate or lift-of. The resulting article is a patterned linear polarizer.

### Aromatic Polymer

The polymeric lyotropic liquid crystal solution or multi-component lyotropic liquid crystal solution includes an aromatic polymer. Aromatic polymers capable of forming a lyotropic liquid crystal in aqueous solution are used. The aromatic polymers can include, for example, copolymers and block copolymers. The concentration of the aromatic polymer in solution should be high enough that a liquid crystal phase is obtained. However, the concentration of the aromatic polymer should be low enough that the viscosity of the lyotropic liquid crystal solution is suitable for coating.

An aromatic polymer can be of a structure:

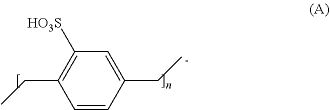

or an alkali metal, ammonium, or quaternary ammonium salt thereof, wherein the number (n) of segments of structure (A) in the aromatic polymer is an integer in a range from 25 to 10,000. This aromatic polymer of structure (A) is referred to as poly(monosulfo-p-xylene). Examples of alkali metals for alkali metal salts of structure (A) are Na, K, and Cs.

An aromatic polymer can be of a structure:

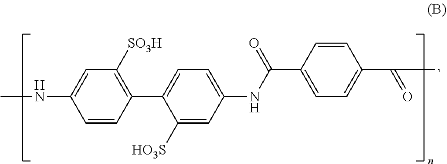

or an alkali metal, ammonium, or quaternary ammonium salt thereof, wherein the number (n) of segments of structure (B) in the aromatic polymer is an integer in a range from 20 to 20,000. This aromatic polymer of structure (B) is referred to as poly(2,2′-disulfo-4,4′-benzidine terephthalamide).

### Doping-Passivation Solution

Both iodine and an iodide salt are needed in the doping-passivation solution of the First Embodiment. In the case of KI as the iodide salt, the weight ratio of KI to iodine (I₂) can range between 2:1 and 20:1. Example 3 shows the case where the weight ratio of KI:iodine:water is 10:1:100. If using Sr²⁺ as the multi-valent cations, the cations can be obtained by dissolving SrCl₂ in water. Example 3 shows the case where the weight ratio of SrCl₂:water is 10:100. More generally, the weight ratio of SrCl₂:water can vary between 1:100 and 20:100. If using Al³⁺ as the multi-valent cations, the cations can be obtained by dissolving AlCl₃ in water. The weight ratio of AlCl₃:water can vary between 1:100 and 20:100. Water can be used as the sole solvent of the doping-passivation solution. Other examples of possible solvents are: methanol, ethanol, propanol, butanol, acetone, methyl ethyl ketone, ethyl methyl ether, and diethyl ether. Alternatively, a mixture can be used as a solvent. For example, a water:ethanol mixture can be used as the solvent, with the water:ethanol ratio ranging between 50:50 and 100:0.

### Anisometic Dye

In some embodiments, the aromatic polymer lyotropic liquid crystal includes one or more dyes.

Both anionic and cationic dyes may be used. Cationic dyes may be preferred.

Examples of commercially available anionic dyes include but are not limited to Direct Yellow 4, Direct Yellow 12, Direct Red 23, Direct Blue 51, Direct Blue 71.

Both commercially available and specialty cationic dyes can be used. The commercially available cationic dyes include but are not limited to Basic Yellow 1, Basic Yellow 6, Basic Yellow 28, Basic Yellow 29, Basic Yellow 40, Basic Orange 21, Basic Red 5, Basic Red 14, Basic Red 15, Basic Red 18, Basic Red 22, Basic Red 46, Basic Red 51, Basic Blue 3, Basic Blue 9, Basic Blue 41, Basic Blue 54, Basic Violet 7, Basic Violet 15, Basic Violet 16. Specialty cationic dyes include but not limited to MDEPAP (TCI America); 4-[4-(Dimethylamino)styryl]-1-methylpyridinium iodide (Sigma Aldrich).

In some embodiments, the cationic dye includes two cationic dyes that cooperate to form a grey or colorless polarizer. In some embodiments, the cationic dye includes three cationic dyes that cooperate to form a grey or colorless polarizer. In some embodiments, the cationic dye includes two or three cationic dyes that cooperate to form a grey polarizer. In some embodiments, the cationic dye includes two or three cationic dyes that cooperate to form a colorless polarizer.

In some embodiments, the specialty cationic dye can have the general structure:

A-D

A-Y₁═Y₂-D.

A-Y₁═Y₂-E-Y₃═Y₄-D,or

A-Y₁═Y₂-E₁-Y₃═Y₄-E₂-Y₅═Y₆-D.

In the above structures A is selected from the following cationic substructure

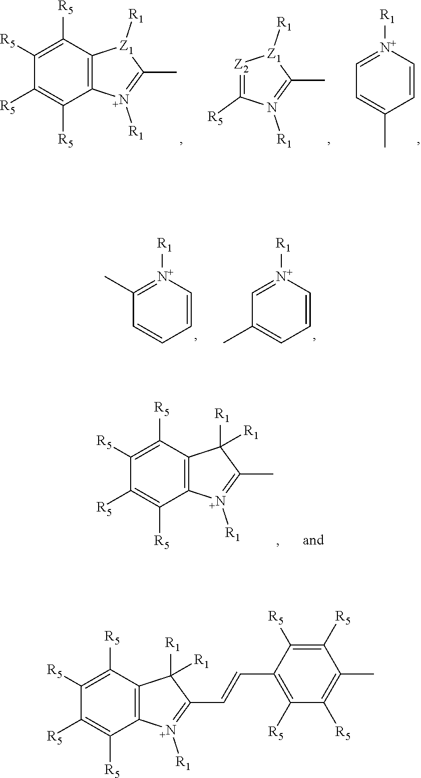

where the positive charge of the cation compensated by an anion. Example of anions include F⁻, Cl⁻, Br⁻, I⁻, HCOO⁻, CH₃COO⁻, H₂PO₄⁻, SO₄²⁻, CH₃SO₄⁻, BF₄⁻, ClO₄⁻.

R₁ are each independently alkyl or phenyl groups. R₅ are each independently H, alkyl, hydroxy, alkoxy, F, Cl, Br, I, amine, alkylamine, or NO₂.

Z₁ and Z₂ are each independently S, O, CH, or N.

Y₁, Y₂, Y₃, Y₄, Y₅, Y₆, are each independently CH or N. E,

E₁, and E₂ are each independently

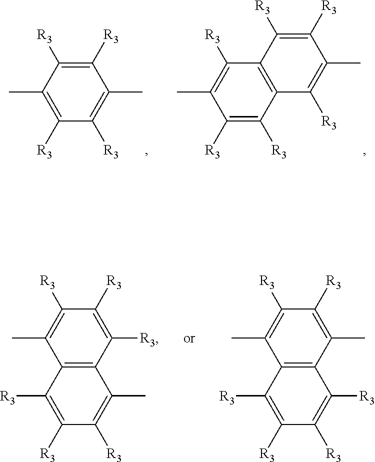

where each R₃ is independently H, alkyl, hydroxy, alkoxy, F, Cl, Br, I, amine, alkylamine, NO₂.

D is any of the structures of A or

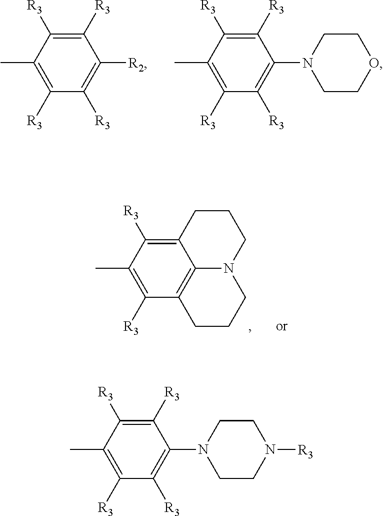

where R₂ is selected from NH₂, NHR₄, NR₄R₆, OH, OR₆. R₄ and R₆ are each independently CH₃, C₂H₅, C₃H₇, C₄H₉, CH₂OH, C₂H₄OH, C₃H₆OH, CH₂CN, CH₂-Ph, C₂H₄CN, CH₂Cl, CH₂Br, C₂H₄Cl, C₂H₄Br, C₂H₄-Ph (Ph is Phenyl).

In some embodiments the cationic dye is dye (C), dye (D), dye (E), dye (F), dye (G), dye dye (H), dye (K), dye (L), or combinations thereof. Please refer to Example 3 of US2023/0145287 for a description on how to prepare the cationic dye C. Please refer to Example 4 of US2023/0145287 for a description on how to prepare the cationic dye G. Please refer to Example 5 of US2023/0145287 for a description on how to prepare the cationic dye K. Please refer to Example 6 of US2023/0145287 for a description on how to prepare the cationic dye L. US2023/0145287 is incorporated by reference herein.

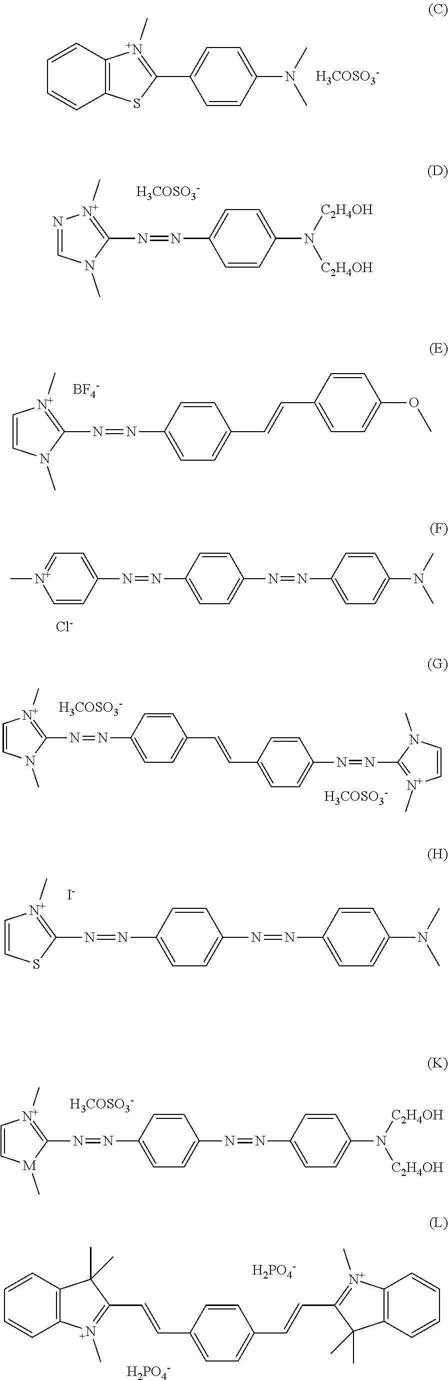

The present invention is illustrated by the following examples. It is to be understood that the particular examples, materials, amounts, and procedures are to be interpreted broadly in accordance with the scope and spirit of the invention as set forth herein.

### EXAMPLES

All reagents, starting materials and solvents used in the following examples were purchased from commercial suppliers (such as Sigma-Aldrich Corporation, St. Louis, Mo.) and were used without further purification unless otherwise indicated.

Unless otherwise indicated, all percentages indicate weight percents.

### Example 1—Aromatic Polymer of Structure (A)

In this Example 1, synthesis of an aromatic polymer of structure (A), sodium salt, or poly(monosulfo-p-xylene), sodium salt, is described. The reaction scheme is as follows:

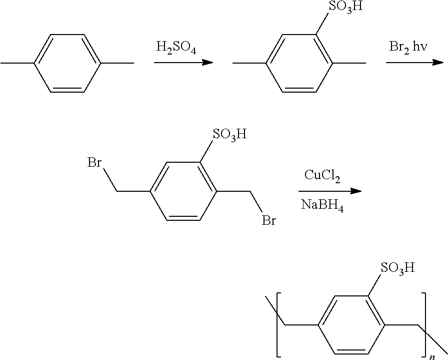

300 ml of sulfuric acid was added to 212 g of p-xylene at 90° C. The reaction mass was stirred at 90-100° C. for 30 min then cooled to 20-25° C. and poured into a beaker with 500 g of mixture of water and ice. The resulting suspension was separated by filtration and the filter cake rinsed with cool (5° C.) solution of 300 ml of hydrochloric acid in 150 ml of water.

The material was vacuum dried at 50 mbar and 50° C. for 24 hrs. Yield of 2,5-dimethylbenzene-sulfonic acid was 383 g (contained 15% water).

92.6 g of 2,5-dimethylbenzene¬sulfonic acid was added to 1700 ml of chloroform and the mixture was purged with argon gas. Then it was heated to boiling with a 500 W lamp placed right against the reaction flask so that stirred contents of the flask was well lit. 41 ml bromine in 210 ml of chloroform was added dropwise within 4-5 hrs to the agitated boiling mixture. Once all bromine had been added the light exposure with refluxing continued for an extra hour. 900 ml of chloroform was distilled and the reaction mass was allowed to cool overnight. Precipitated material was isolated by filtration, the filter cake was rinsed with 100 ml of chloroform, squeezed and recrystallized from 80 ml of acetonitrile. Yield of 2,5-bis(bromomethyl)benzenesulfonic acid was 21 g.

4.0 g of sodium borohydride in 20 ml of water was added to a stirred mixture of 340 mg of CuCl₂, 10.0 g of 2,5-bis(bromomethyl)benzenesulfonic acid, 10.4 g of sodium bromide, 45 ml of amyl alcohol and 160 ml of degassed water and the reaction mass was agitated for 10 min. Then the mixture was transferred to a 1-liter reparatory funnel, 300 ml of water was added and after shaking the mixture was allowed to stand for an hour. The bottom layer was isolated, clarified by filtration and ultrafiltered using a polysulfone membrane with 10,000 molecular weight cut-off. Yield of the aromatic polymer of structure A, Na salt is 4.0 g (on dry basis).

### Example 2—Aromatic Polymer of Structure (B)

In this Example 2, synthesis of a aromatic polymer of structure (B), sodium salt, or poly(2,2′-disulfo-4,4′-benzidine terephthalamide), sodium salt, is described. The reaction scheme is as follows:

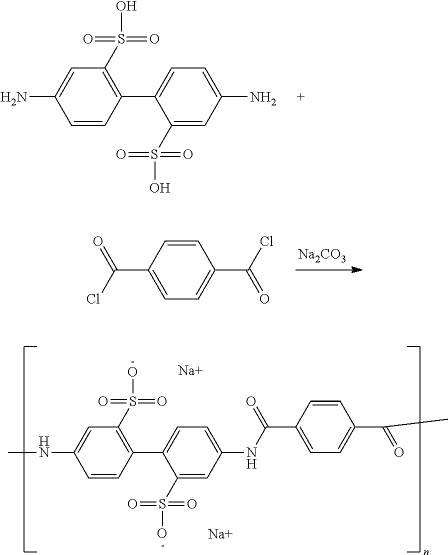

10.0 g (0.029 mol) of 4,4′-Diaminobiphenyl-2,2′-disulfonic acid was mixed with 3.1 g (0.029 mol) of Sodium Carbonate and 700 ml of water and stirred till dissolution. While stirring the obtained solution a solution of 6.5 g (0.032 mol) of Terephthaloyl Chloride in 700 ml of Toluene was added followed by a solution of 6.1 g of Sodium Carbonate in 100 g of water. The stirring was continued for 3 hours. Then the emulsion was heated to boiling and Toluene distilled out. The resulting water solution was ultrafiltered using PES membrane with MW cut-off 20K Dalton. Yield of the polymer was 180 g of 8% water solution.

Gel permeation chromatography (GPC) analysis of the sample was performed with Hewlett Packard 1260 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as GPC standard. The calculated number average molecular weight Mn, weight average molecular weight Mw, and polydispersity PD were found as 1.1×10⁵, 4.6×10⁵, and 4.2 respectively.

### Example 3—A Patterned Linear Polarizer Prepared by Coating, Printing and Staining

Details of the procedures for preparing a sample of the patterned polarizer are given in this Example 3.

A polymeric lyotropic liquid crystal solution is prepared by dissolving the Example 1 polymer in water at a concentration of 16%. The polymeric solution is coated on the coatable substrate using Mayer rod #4,and the resulting coated substrate is dried in an oven at 60° C. for 5 minutes. Thickness of the resulting polymeric coating layer is approximately 0.8 μm.

### 1. Coatable Substrate Preparation

Saponified TAC (80 μm thick) was used as the coatable substrate. The substrate was primed using Mayer rod #2 with the water-based primer solution, 0.5% solids content and dried at 60° C. for 5 minutes. The designation #2 here and thereafter refers to the diameter of the wire on the Mayer rod in mils. The dry thickness of the primer was 30 nm.

2. A polymeric lyotropic liquid crystal solution and aromatic polymer layer preparation Polymer from Example 1 is dissolved in water at a concentration of 16%. The polymeric solution is coated on the coatable substrate using Mayer rod #4, and the resulting coated substrate is dried in an oven at 60° C. for 5 minutes. Thickness of the resulting polymeric coating layer is approximately 0.8 μm.

### 3. Ink Formulation and Ink-Jet Printing

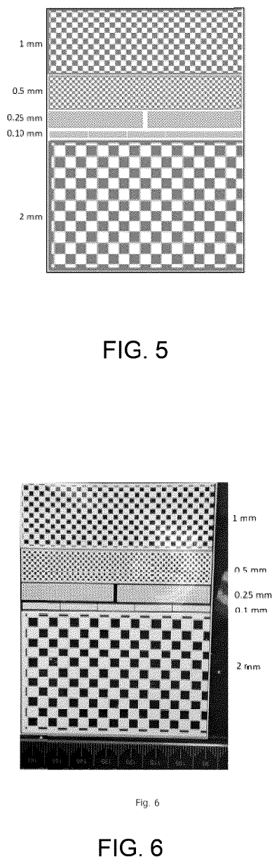

An ink formulation is prepared containing alcohol-based dye solution along with other additives such as co-solvents, viscosity and surface tension modifiers. Commercial T-Rex Premium alcohol ink was used for printing. To improve jetting property 0.1 weight % of glycerol was added to increase viscosity of the ink. The ink-jet printer is then programmed to deposit the ink formulation onto the polymer layer in a specific pattern, using a nozzle array that can create micron-sized droplets of ink. Chessboard patterns of various sizes were generated using a computer. The pattern was printed out on the coated substrate using a photoprinter Epson ET-15000 and is shown in FIG. 5.

### 4. Staining

The doping-passivation solution is a solution containing doping and passivation constituents. The doping constituents are iodine (I₂) and iodide salts. In this case, the iodide salt is KI and the passivation constituent is AlCl₃. The doping-passivation solution is prepared as follows. Iodine (1 weight part) and KI (10 weight parts) are mixed and dissolved in 100 weight parts of water.

The mixture is stirred for 10 minutes with no heating. The passivation constituent, AlCl₃ (10 weight parts), is added and mixed for 30 minutes with no heating. The coated substrate is dipped in the doping-passivation solution for 20 seconds. Polymer areas covered with the ink remain transparent and their optical properties are not altered in the process.

FIG. 4 is a micro-photographic image of a patterned linear polarizer layer obtained by shear coating of the polymeric lyotropic liquid crystal, drying, manual masking and selective doping with iodine.

### 5. Rinsing

The printed and stained substrate is then dipped in a rinse solution that is 95% EtOH/5% water solution for 5 seconds. Excess liquid is blown off of the coated substrate using compressed air. The coated substrate is dried in an oven at 60° C. for 5 minutes. The rinsing liquid removes (1) excess of the staining solution off the substrate; (2) printed ink pattern, exposing the areas of the substrate that were protected by the inkjet-printed layer, leaving behind a micro-patterned polarizer. The process of micropatterning of optical coatings using ink-jet printing is a relatively simple and cost-effective process that can be used to create complex patterns with high precision and accuracy.

A micro-photograph of the patterned linear polarizer prepared with the use of ink-jet printing is shown in FIG. 6.

### Example 4—A Patterned Linear Polarizer Prepared by Coating, Photo-Lithography and Staining

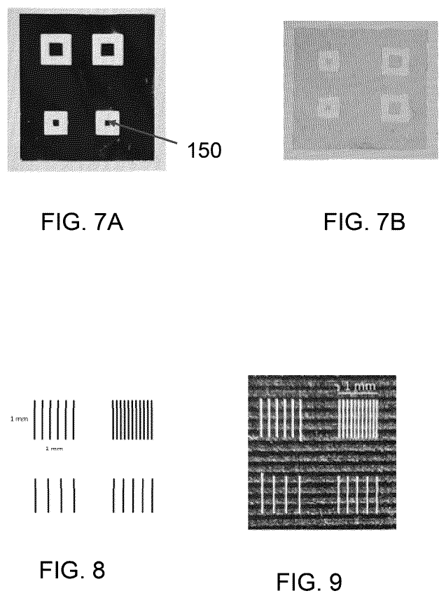

Details of the procedures for preparing a patterned polarizer samples are given in Example 3 except for step 3 where the standard photo-lithography process is used to create a mask on the outer surface of the coated polymer layer. The light polarizing properties are illustrated by FIG. 7A and FIG. 7B. The inner square 150 is 1 mm×1 mm. FIG. 7B is the micro-photographic image of a patterned linear polarizer layer of FIG. 7A rotated 90 degrees (clockwise) to illustrate the polarizing effect of Example 4.

### Example 5—A Patterned Linear Polarizer Prepared by Coating, Staining and Laser Engraving

In this example we discuss creating of a patterned polarizer using laser engraving technology. The process involves several steps.

### 1. Substrate Preparation and Coating.

The details of a coatable substrate preparation and a polymeric lyotropic liquid crystal solution and aromatic polymer layer preparation are the same as in Example 3.

### 2. Staining and Rinsing.

The coated substrate was stained for 20 s to the transmittance of 40% using the staining solution, followed by rinsing with 95% EtOH solution which removes excess of the staining solution off the substrate leaving behind a polarizing coating.

### 3. Laser Engraving.

A 2.5 W laser engraving machine was used to pattern the polarizing coating. The power of the laser was adjusted to ablate only the coated polarizer layer but keep the substrate intact. The power used was 125 mW, focused into a 50 um spot. The test pattern was designed as shown in FIG. 8. Each cell of multiple lines has a lateral width value of 1 mm and a lateral height value of 1 mm.

The engraving speed was set to 3000 mm/min. As the laser beam follows the predetermined pattern it removes the polarizing material from the exposed areas and produces the patterned polarizer coating as shown by FIG. 9. Each cell of multiple lines has a lateral width value of 1 mm and a lateral height value of 1 mm.

### Example 6—A Patterned Linear Polarizer Prepared by Coating, Staining and Laser Irradiation

This example demonstrates a variation of the laser patterning approach presented in the Example 5. In the cases where the characteristic patterning features are 100 um and less the precision of mechanical positioning of the gravure head may be insufficient to accurately reproduce the required pattern. Instead of drawing the pattern with the laser beam one can use a prefabricated shadow mask and illuminate it with the laser radiation.

The polarizing coating was prepared as described in the Example 5 (steps 1 and 2). The mask was prepared by chemical etching of polished stainless steel (SUS304) and according to the design presented in FIG. 10.

The size of the mask was 10 cm×10 cm, thickness—80 um. Accuracy of the etching was about ±10 um. Each window is rectangular with a lateral length of 180 micrometers and a lateral height of 120 micrometers. Each window had a pitch (window center to center distance from each other) of 288 micrometers in both the length direction and the height direction.

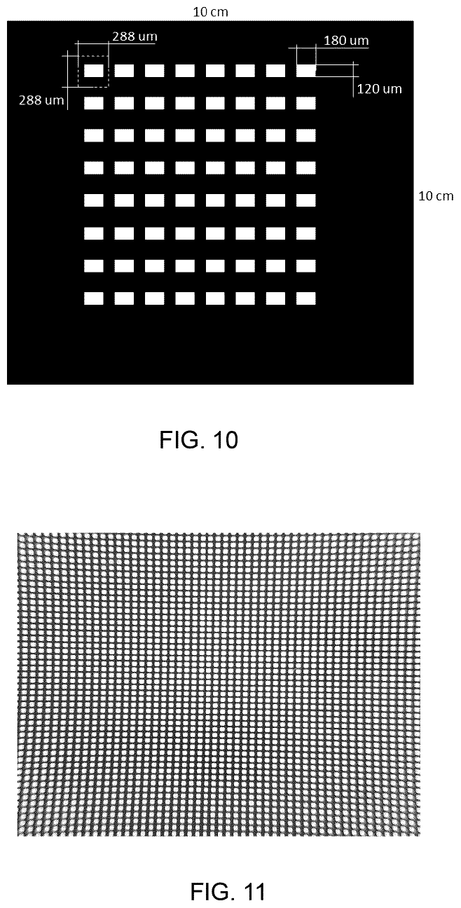

The mask was mounted over the polarizing coating and sequentially illuminated line by line with the 3 mm wide laser beam (wavelength of 405 nm) with the optical power of 200 mW. The shadowed polarizing material remained intact while the exposed areas became transparent. FIG. 11 presents the microphotograph of patterning result.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A patterned linear polarizer, comprising:
a coating layer of 2 micrometers or less in thickness, comprising an aromatic polymer, formed from a lyotropic liquid crystal, dopant, and multi-valent cations, where the coating layer comprises light polarizing areas and light non-polarizing areas, where the light polarizing areas form a pattern.

2. The patterned linear polarizer of claim 1, wherein the dopant comprises iodine.

3. The patterned linear polarizer of claim 2, wherein the coating layer has a thickness of 1 micrometer or less.

4. The patterned linear polarizer of claim 1 where the dopant comprises an anisometric dye.

5. The patterned linear polarizer of claim 4, wherein at least one anisometric dye is a cationic dye selected from the group consisting of dye C, dye D, dye E, dye F, dye G, dye H, dye K, and dye L.

6. The patterned linear polarizer of claim 1, wherein the multi-valent cations is selected from the group consisting of: Ba²⁺, Mg²⁺, Sr²⁺, Al³⁺, La³⁺, Ce³⁺, Fe3+, Cr³⁺, Mn²⁺, Cu²⁺, Zn²⁺, Pb²⁺, Ca²⁺, Ni²⁺, Co²⁺, and Sn²⁺.

7. The patterned linear polarizer of claim 1, wherein the aromatic polymer is of a structure: 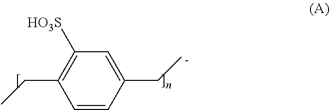
or a salt thereof,
wherein n is an integer in a range from 25 to 10,000.

8. The patterned linear polarizer of claim 1, wherein the aromatic polymer is of a structure: 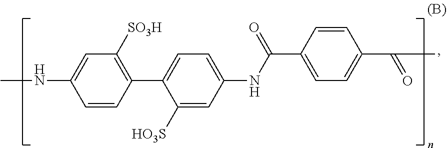
or a salt thereof,
wherein n is an integer in a range from 20 to 20,000.

9. The patterned linear polarizer of claim 1, wherein the aromatic polymer comprises a group (SO₃⁻).

10. The patterned linear polarizer of claim 1, wherein a largest lateral dimension of the light polarizing areas is from 1 micrometer to 10 millimeters.

11. The patterned linear polarizer of claim 1, wherein the light polarizing areas have a total transmittance, averaged over 400 nm to 700 nm, of 37% or greater, and a polarization efficiency, averaged over 400 nm to 700 nm, of 96% or greater.

12. The patterned linear polarizer of claim 1, wherein:
the aromatic polymer is a sodium salt of a structure: 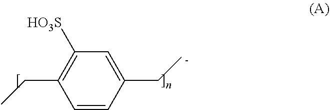
wherein n is an integer in a range from 25 to 10,000; and
the multi-valent cations are selected from Al³⁺ and Sr²⁺.

13. A patterned circular polarizer comprising the patterned linear polarizer of claim 1 and a quarter-wave retarder disposed on the coating layer.

14. A method of forming a patterned linear polarizer comprising:
shear coating a lyotropic liquid crystal layer onto a substrate to form an aromatic polymer layer having a thickness of 2 micrometers or less;
applying a dopant and multi-valent cations on the aromatic polymer layer;
forming light polarizing areas and light non-polarizing areas in the aromatic polymer layer to define a patterned linear polarizer.

15. The method of claim 14, wherein the forming step comprises application of the dopant on the aromatic polymer layer and selective removal of areas of the aromatic polymer layer to form light non-polarizing areas.

16. A method of forming a patterned linear polarizer comprising:
shear coating a lyotropic liquid crystal layer onto a substrate to form an aromatic polymer layer having a thickness of 2 micrometers or less;
doping selective areas on the aromatic polymer layer to form light polarizing areas and selectively not doping other areas to form light non-polarizing areas in the aromatic polymer layer to define a patterned linear polarizer; and
applying multi-valent cations on the aromatic polymer layer.

17. The method of claim 16, wherein the doping step comprises applying a mask on the aromatic polymer layer to dope selective areas not covered by the mask and prevent doping of areas covered by the mask.

18. The method of claim 17, further comprising rinsing the aromatic polymer layer to remove excess dopant and the mask.

19. The method of claim 16, wherein the doping step comprises printing a pattern of dopant on selected areas of the aromatic polymer layer to form light polarizing areas and selectively not printing dopant on other areas to form light non-polarizing areas in the aromatic polymer layer to define a patterned linear polarizer.

20. The method of claim 19, further comprising rinsing the aromatic polymer layer to remove excess dopant.
